(19) United States
(12) Patent Application Publication
(10) Pub. No.: US 2003/0111854 A1
(43) Pub. Date: Jun. 19, 2003

(54) Container

(76) Inventor: Robert J. Washek, Dover, MA (US)

Correspondence Address: KRIEGSMAN & KRIEGSMAN, 665 Franklin Street, Framingham, MA, 01702, US

(21) Appl. No.: 10/351,741

(22) Filed: Jan. 27, 2003

Related U.S. Application Data
(63) Continuation of application No. 09/791,168, filed on Feb. 22, 2001.

(51) Int. Cl. A01B 1/02; A47F 13/08; B65F 1/00

(52) U.S. Cl. 294/55; 220/908

(57) ABSTRACT

A one-piece container for collecting waste materials, such as dirt, debris and trash, includes a bottom wall and a side wall which together define an interior cavity for holding the waste materials and a filling aid for facilitating the process of inserting the waste materials within the interior cavity. The container is constructed of a rigid and durable material. The sidewall includes a free end which defines a top opening which provides access to the interior cavity. The container can be disposed on a support surface in either a vertical position or an angled position. The filling aid is integrally formed onto the free end of the sidewall and includes a panel having an outer edge which is straight. The filling aid extends out from the free end of the sidewall at an acute angle of approximately 45 degrees and enables the container to be also disposed on a support surface at an angled position so that waste materials can be easily inserted into the interior cavity. In addition, the filling aid prevents the container from rolling over about its longitudinal axis when it is resting at its angled position.

### BACKGROUND OF THE INVENTION

The present invention relates generally to containers and more particularly to containers used in the collection of waste materials, such as dirt, debris and trash, which may be found either inside and/or outside a home.

Containers, of various sizes and shapes, are commonly used to collect waste materials, such as dirt, debris and trash.

These containers usually comprise a generally flat, bottom wall and a sidewall which is integrally formed onto the outer periphery of the bottom wall. The sidewall extends out perpendicularly from the bottom wall so as to define an interior cavity therebetween. The free end of the sidewall defines a top opening which provides access to the interior cavity. A cover is often removably mounted over or attached to the top opening to enclose the interior cavity, thereby precluding waste material collected within the container from being removed. One or more handles are also often mounted or formed onto the sidewall to facilitate the handling of the containers.

Containers of the type described above are often used in yard waste applications. Specifically, the collected yard waste is disposed into the interior cavity of the container through the top opening using one or more conventional yard tools, such as shovels or rakes, and/or using the arms of a worker in a scooping manner.

Yard waste is typically deposited into a container of the type described above using one of two principal methods.

As a first method, yard waste is disposed into the interior cavity with the container disposed in its vertical position such that the end wall lies flat and in contact with the ground surface. With the container disposed in its vertical position, the worker is required to lift the waste materials from off the ground and drop it into the interior cavity through the top opening.

Although commonly performed during the collection of yard waste, the first method described above suffers from a notable drawback. Specifically, it has been found that the process of lifting the waste materials from off the ground and in through the top opening creates a significant amount of strenuous and physically demanding activity for the worker, which is highly undesirable.

As a second method, yard waste is disposed into the interior cavity with the container disposed in its horizontal position such that the rounded sidewall lies against the ground surface. With the container disposed in its horizontal position, the worker is required to laterally displace the debris into the interior cavity through the top opening.

Although commonly performed during the collection of yard waste, the second method described above suffers from notable drawbacks. Specifically, it has been found that the container is relatively unstable when positioned on its rounded sidewall, thereby rendering the process of laterally displacing the yard waste into the container more difficult, which is highly undesirable. In addition, it has been found that the rounded nature of the top opening of the container causes a limited portion of the container to be in contact with the ground surface. As a result, when the yard waste is laterally displaced towards the barrel, the lack of a means for funneling the yard waste into the interior cavity causes yard waste to be displaced between the ground surface and the sidewall, which is highly undesirable. Furthermore, with the container disposed in its horizontal position, it has been found to be difficult to displace the collected waste materials past the top opening and down into the interior cavity towards the bottom panel.

Accordingly, containers which are designed to facilitate the collection of yard waste are well known in the art.

In U.S. Pat. No. 4,312,531 to R. H. Cross, there is disclosed a filling aid for plastic trash bags and the like. The filling aid is selectively positionable within a can-received flexible bag for the stabilization and protection of the bag and for the guiding of debris and the like into the bag. The aid includes an elongated tubular split sleeve having open inner and outer ends and being of a resiliently flexible nature for a selective varying of the circumferential size thereof. The outer end of the sleeve includes an outwardly curled flange engageable over a can rim for the clamping of a bag thereto. An outwardly flaring scoop extends longitudinally from the flanged end of the sleeve, tapering from engagement with the periphery of the sleeve about approximately one half the circumference thereof, to a straight outer edge of a length greater than the normal diameter of the sleeve.

The filing aid described in U.S. Pat. No. 4,312,531 to R. H. Cross suffers from a notable drawback. Specifically, the filing aid is designed to be removably mounted onto a separate can. As a result, the user is required to purchase both the filing aid and a can, thereby increasing costs, which is highly undesirable. In addition, the user is required to removably mount the filing aid onto a desired can, thereby rendering usage more complicated, which is highly undesirable.

In U.S. Pat. No. 5,183,339 to W. J. Williams, there is disclosed a bag and an adjustable bag opener frame. The frame maintains the entrance leading into the interior of the bag fully open, the frame having an elongated linear base with a curved member carried between its opposite ends. The ends of both the base and the curved member are joined by an elbow fitting while the curved member is divided into two portions selectively joined at opposing ends by a friction clamp or the like. The frame is inserted into the mouth of a trash bag and the curved member is secured to provide a rigid frame separating the edge marginal region of the bag wall defining the entrance.

The bag and adjustable bag opener frame described in U.S. Pat. No. 5,183,339 to W. J. Williams suffers from notable drawbacks. As one drawback, the adjustable bag opener frame is removably mounted onto the bag, thereby increasing overall costs and rendering usage more complicated, which is highly undesirable. As another drawback, the bag is a conventional flexible trash bag which lacks the structural stability to be disposed in a vertical position. Because the bag is incapable of being disposed in a vertical position, the user is required to bend over to lift and handle the bag, which is highly undesirable.

Containers of the type described above are also used in home interior applications. Specifically, waste materials inside a home are deposited into the interior cavity of the container through the top opening either by hand or by using one or more conventional home interior cleaning tools, such as a broom and dustpan. However, it should be noted that containers used in home interior applications are generally smaller in size than containers used in yard waste applications. Furthermore, it should also be noted that containers used in home interior applications are usually either rectangular or circular in lateral cross-section, whereas containers used in yard waste applications are most often, but not always, circular in lateral cross-section.

### SUMMARY OF THE INVENTION

It is an object of the present invention to provide a new and improved container for collecting waste materials, such as dirt, debris and trash, which may be found inside and/or outside a home.

It is another object of the present invention to provide a container which is adapted to facilitate the collection of waste materials.

It is yet another object of the present invention to provide a container which is rigid, durable and structurally stable.

It is still another object of the present invention to provide a container which has a limited number of parts, which is easy to use and which is inexpensive to manufacture.

Accordingly, there is provided a one-piece container for collecting waste materials, such as dirt, debris and trash, said container comprising a bottom wall and a side wall which together define an interior cavity for holding the waste materials, and further comprising a filling aid formed onto the side wall for facilitating the process of inserting the waste materials into said barrel.

Various other features and advantages will appear from the description to follow. In the description, reference is made to the accompanying drawings which form a part thereof, and in which is shown by way of illustration, a specific embodiment for practicing the invention. This embodiment will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings wherein like reference numerals represent like parts:

FIG. 1 is a right side view of a container constructed according to the teachings of the present invention, the container being shown disposed on a support surface in its vertical position;

FIG. 2 is a right side plan view of the container of FIG. 1, the container being shown positioned on a support surface in its angled position;

FIG. 3 is a top view of the container of FIG. 1;

FIG. 4 is a bottom view of the container of FIG. 1;

FIG. 5 is a front view of the container shown in FIG. 1; and

FIG. 6 is a back view of the container shown in FIG. 1.

### DETAILED DESCRIPTION OF THE PREFERRED EMBODIMENT

Referring now to the drawings, there is shown a container constructed according to the teachings of the present invention, the container being identified generally by reference numeral 11. As will be described further in detail below, container 11 can be used to collect waste materials, such dirt, debris and trash, inside or outside a home.

Container 11 comprises a bottom wall 13 and a side wall 15 which together define an interior cavity 17 for collecting the waste materials and a filling aid or scoop 19 integrally formed onto side wall 15 for facilitating the process of inserting waste materials into interior cavity 17.

Bottom wall 13 is circular in shape and sidewall 15 is integrally formed onto the outer periphery of bottom wall 13.

Sidewall 15 extends out perpendicularly from bottom wall 13. As will be described further in detail below, waste materials deposited into container 11 collects within interior cavity 17. Free end 21 of sidewall 15 defines a top opening which provides access to interior cavity 17.

Outer surface 23 of sidewall 15 is shaped to include a handle 25 for gripping container 11. Furthermore, a separate cover (not shown) may be provided for use with container 11 which can be removably mounted over top opening 21 so as to enclose interior cavity 21, thereby precluding the waste material collected within container 11 from being removed or falling out.

It should be noted that container 11 is constructed of a durable and rigid plastic or metal, so as to ensure its structural integrity and stability, which is an object of the present invention. Furthermore, because filling aid 19 is integrally formed as a part of container 11, container 11 is has a limited number of parts, is inexpensive to manufacture and is easy to use, which is a principal object of the present invention.

It should be noted that except for filling aid 19 of container 11 represents a conventional container which is used in the collection of waste materials.

Filling aid 19 which as noted above is integrally formed onto free end 21 of sidewall 15 is generally in the shape of an elongated panel 27 which extends out from free end 21 of container 11 at an angle A of approximately 45 degrees from the longitudinal axis L of container 11. Panel 27 includes an outer edge 29 which is straight and a pair of side edges 31 and 33.

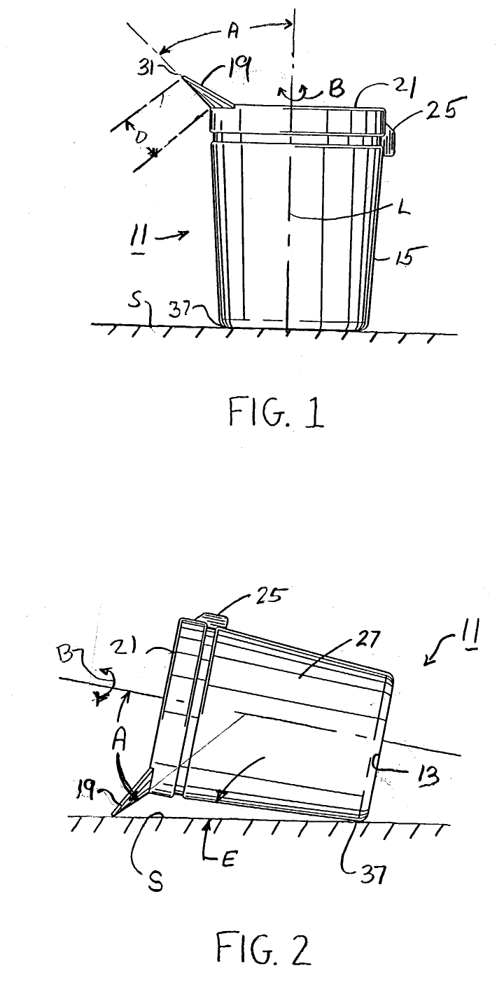

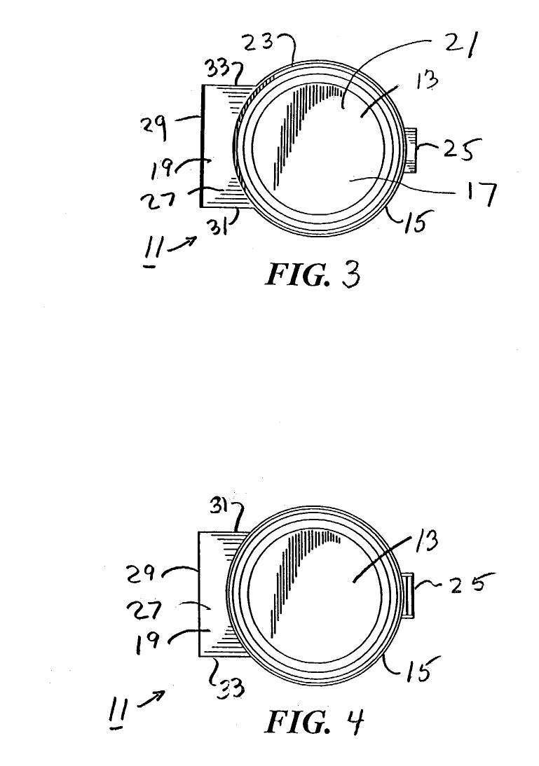

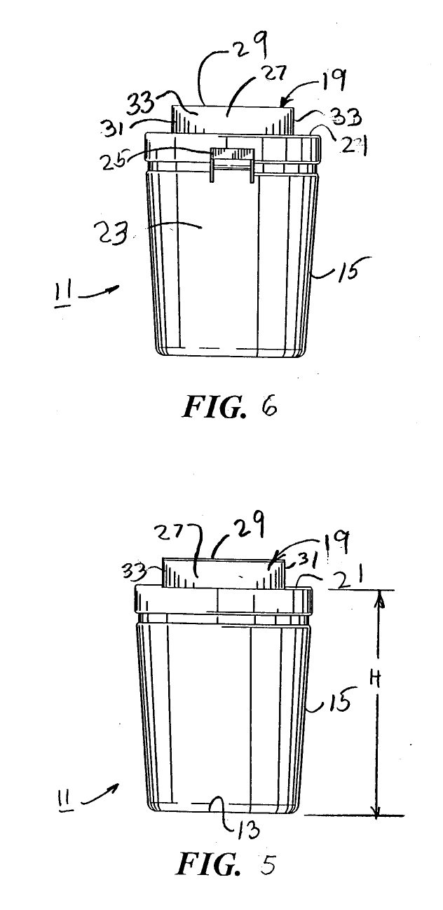

As can be appreciated, container 11 can be disposed on a support surface S in either a vertical position, as shown in FIG. 1, or an angled position where it is seated somewhat sideways as shown in FIG. 2. It should be noted that, because container 11 is capable of being used inside and/or outside a home, support surface S represents any indoor or outdoor surface, such as a floor, ground or yard.

The length D of filling aid 19 is such that with container 11 disposed in its angled position, a portion of the bottom edge 37 of container 11 and outer edge 29 of filling aid 15 lies against support surface S so that container 11 forms an angle E of about 10 degrees with support surface S.

As an example, container 11 can have a height H of about 24 inches and length D of filling aid 19 about 6 inches.

As can be appreciated, with container 11 disposed in its angled position, filling aid 19 serves multiple functions.

As an example, filling aid 19 serves as a stand for propping free end 21 up from surface S, thereby disposing container 11 at an angle E. With container 13 disposed at an angle E, waste materials displaced in through top opening 25 will slide down through interior cavity 17 and will collect at the bottom of container 11, which is highly desirable.

As another example, filling aid 19 serves as a stabilizing leg which abuts against surface S, when container 11 is resting at an angle as shown in FIG. 2 thereby precluding rounded container 11 from rolling along its longitudinal axis L, as represented by arrow B in FIGS. 1 and 2, upon the introduction of exterior rotational forces, such as if wind urges container 13 to rotate or if containerl3 is disposed on a support surface which is not level, which is highly desirable.

As another example, filling aid 19 serves as a dustpan whose outer edge 29 lies flat against surface S, thereby facilitating the process of laterally sliding waste materials into container 13, which is highly desirable.

With container 11 disposed in its vertical position as shown in FIG. 1, bottom wall 13 of container 11 lies flat against support surface S. As can be appreciated, with container 11 disposed in its vertical position, waste materials deposited within container 13 remain collected on bottom wall 13 and is less susceptible of being accidentally removed. In addition, with container 11 disposed in its vertical position, container 11 can be easily handled in such circumstances as if the waste materials within container 113 are to be removed or if container 11 is to be moved to a different location.

In use, container 11 can be used to collect waste materials, such as dirt, debris and trash, located on a surface S in the following manner. Specifically, as shown in FIG. 2, container 11 is disposed in its angled position such that edge 29 of filling aid 19 lies flat against support surface S. With container 11 so positioned in its angled position, waste materials are deposited into interior cavity 17 of container 11 via filling aid 19, such as by using a rake or a broom. Specifically, waste materials are pushed onto filling aid 19, and then from filling aid 19 through top opening and down into interior cavity 17.

As can be appreciated, because edge 29 and a part of edge 37 lie against surface S, filling aid 19 acts as a dustpan which serves to efficiently funnel all of the laterally displaced waste materials into container 11. In addition, because container 11 is disposed at an angle, as the waste materials are displaced in through top opening, gravity causes the waste materials to slide down inside interior cavity and collect on bottom wall 13. Furthermore, because straight edge 29 lies flat against surface S, filling aid 19 serves to ensure that container 11 does not rotate about its longitudinal axis L.

After the waste materials are fully deposited within interior cavity 17, container 11 can be disposed in its vertical position as shown in FIG. 1 using handle 25 such that end panel 17 lies flat on top of surface S. Container 11 preferably remains in its vertical position until such time that the waste materials are to be emptied from container 11.

It should be noted that, due to the rigid structural integrity of container 11, container 11 will stay in its vertical position, thereby ensuring that the waste materials can not accidentally spill out from container 11.

As can also be appreciated, when being used for inside applications, dirt or other matter can be easily pushed into container 13 with a broom and without using a dustpan.

The embodiment shown in the present invention is intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A container for collecting waste materials, such as dirt, debris and trash, comprising:
(a) a bottom wall,
(b) a side wall, and
(c) a filling aid integrally formed onto said side wall, said filling aid facilitating the process of inserting the waste materials into said container.

2. The container of claim 1 wherein said sidewall is integrally formed onto the outer periphery of the bottom wall and extends upward therefrom.

3. The container of claim 2 wherein said bottom wall and said sidewall together define an interior cavity into which waste material is collected.

4. The container of claim 3 wherein said sidewall includes a free end which defines a top opening which provides access to the interior cavity.

5. The container of claim 1 wherein said container is constructed of a rigid and durable material, such as plastic.

6. The container of claim 5 wherein said filling aid is integrally formed onto the sidewall of said container.

7. The container of claim 6 wherein said filling aid is integrally formed onto the free end of the sidewall of said container.

8. The container of claim 7 wherein said filling aid extends out from the free end of the at least one sidewall of said container at an angle relative to the longitudinal axis of the container.

9. The container of claim 8 wherein said filling aid extends out from the free end of the at least one sidewall of said container at an angle of approximately 45 degrees.

10. The container of claim 6 wherein said filling aid comprises an elongated panel having a straight outer edge.

11. The container of claim 10 wherein said filling aid is sized and shaped to assist in guiding the waste materials into the interior cavity of said barrel.

12. The container of claim 11 wherein said container is adapted to be disposed on a support surface in either a vertical position or an angled position.

13. The container of claim 12 wherein the straight edge of said filling aid and an edge of the bottom wall lies against the support surface when said container is disposed in its angled position.

14. The container of claim 13 wherein the bottom wall of said container lies flat against the support surface when said container is disposed in its vertical position.

15. The container of claim 14 wherein the container forms an angle of about 10 degrees with the support surface when the container is disposed in its angled position.

16. The container of claim 1 wherein said bottom wall is in the shape of a circular disc.

17. The container of claim 1 wherein said container is a one-piece body made of a rigid plastic material.
